(19) United States
(12) Patent Application Publication
(10) Pub. No.: US 2014/0210941 A1
(43) Pub. Date: Jul. 31, 2014

(54) IMAGE CAPTURE APPARATUS, IMAGE CAPTURE METHOD, AND IMAGE CAPTURE PROGRAM

(71) Applicant: Sony Corporation, Tokyo (JP)

(72) Inventor: WeiJie Wang, Tokyo (JP)

(73) Assignee: Sony Corporation, Tokyo (JP)

(21) Appl. No.: 14/151,984

(22) Filed: Jan. 10, 2014

(30) Foreign Application Priority Data
Jan. 29, 2013 (JP) 2013-014722

(51) Int. Cl. H04N 5/232

(52) U.S. Cl. CPC H04N 5/23238
USPC 348/36

(57) ABSTRACT

An image capture apparatus includes an image capture unit configured to perform image capture to convert incident light into an electrical signal to generate one or more images; an image combining unit configured to combine a plurality of images generated by the image capture unit to generate an image having a size that is greater than or equal to an angle of view; and a mode decision unit configured to decide whether or not generating, performed by the image combining unit, the image having a size that is greater than or equal to the angle of view is optimum, on the oasis of the one or more images generated by the image capture unit.

### CROSS REFERENCE TO RELATED APPLICATIONS

This application claims the benefit of Japanese Priority Patent Application JP 2013-014722 filed Jan. 29, 2013, the entire contents of which are incorporated herein by reference.

### BACKGROUND

The present technology relates to an image capture apparatus, an image capture method, and an image capture program.

In recent years, in order to improve user convenience, image capture apparatuses are equipped with a so-called automatic photography mode in which selection and setup of photography modes and so on are automatically performed. In the automatic photography mode, based on photography information, such as brightness information, backlight-detection information, subject-detection information, photography of scenery, such as a night view, a backlit situation, a person, and a landscape view, are automatically activated to allow for photography of an effective picture without manually performing scene switching. Because of this advantage, the automatic photography mode has been widely used by many users.

For recommending a photography mode and simplifying the setup thereof, for example, Japanese Unexamined Patent.

Application Publication No. 2009-207170 discloses a technology that enables a photography mode to be set up intuitively and efficiently.

### SUMMARY

However, since the automatic photography mode has a limitation in that it can only be activated for only a photographic method equivalent to typical single-picture photography. Thus, the automatic photography mode is not applicable to, for example, a so-called panoramic photography mode in which an image having a size that is greater than or equal to an angle of view is acquired from a plurality of images. Because of that limitation, in the automatic photography mode, for example, the panoramic photography is not automatically activated, and thus the user who wishes to use the automatic photography mode typically has to switch the modes manually.

For example, for a specific mode, such as the panoramic photography mode, there are cases in which general users do not know about the availability of the photography mode, do not know how to switch a mode to the photography mode, and do not understand well in which situation the photography mode is to be used. Accordingly, there is a problem in that how those users are to be prompt to use the photography mode to perform photography.

In view of such a problem, it is desirable to provide an image capture apparatus, an image capture method, and an image capture program which are capable of easily deciding whether or not performing photography in a mode for acquiring an image having a size that is greater than or equal to an angle of view is appropriate.

In order to overcome the foregoing problem, according to one embodiment of the present technology, there is provided an image capture apparatus including an image capture unit configured to perform image capture to convert incident light into an electrical signal to generate one or more images; an image combining unit configured to combine a plurality of images generated by the image capture unit to generate an image having a size that is greater than or equal to an angle of view; and a mode decision unit configured to decide whether or not generating, performed by the image combining unit, the image having a size that is greater than or equal to the angle of view is optimum, on the basis of the one or more images generated by the image capture unit.

According to another embodiment of the present technology, there is provided an image capture method including: performing image capture to convert incident light into an electrical signal to generate one or more images; and deciding whether or not generating an image having a size that is greater than or equal to an angle of view is optimum, on the basis of the generated one or more images.

According to yet another embodiment of the present technology, there is provided an image capture program for causing a computer to execute an image capture method including: performing image capture to convert incident light into an electrical signal to generate one or more images; and deciding whether or not generating an image having a size that is greater than or equal to an angle of view is optimum, on the basis of the generated one or more images.

According to the present technology, it is possible to easily decide whether or not performing photography in a mode for acquiring an image having a size that is greater than or equal to an angle of view is appropriate.

### BRIEF DESCRIPTION OF THE DRAWINGS

FIG. 1 is a block diagram illustrating a general configuration of an image capture apparatus according to a first embodiment of the present technology;

FIG. 2 is a block diagram illustrating an overall configuration of the image capture apparatus according to the first embodiment of the present technology;

FIG. 3A depicts a horizontal panoramic image generated by an image combining unit when the image capture apparatus is swept horizontally, and FIG. 3B depicts a vertical panoramic image generated by the image combining unit when the image capture apparatus is swept vertically;

FIGS. 4A, 4B, and 4C are schematic views illustrating an external configuration of the image capture apparatus according to an embodiment of the present technology;

FIG. 5 is a flowchart illustrating an overall flow of processing performed by the image capture apparatus;

FIG. 6 is a flowchart illustrating a flow of decision processing for a first determination criterion;

FIG. 7 illustrates a first example of a degree of connection;

FIGS. 8A and 8B illustrate a second example of the degree of connection;

FIG. 9 is a flowchart illustrating a flow of decision processing for a second determination criterion;

FIG. 10 is a flowchart illustrating a flow of decision processing for a third determination criterion;

FIG. 11 is a schematic view illustrating decision as to whether or not a subject matches a recommended panoramic subject;

FIG. 12A is a table illustrating the first determination criterion, FIG. 12B is a table illustrating the second determination criterion, and FIG. 12C is a table illustrating the third determination criterion;

FIG. 13A depicts a panoramic-photography recommendation screen when the image capture apparatus is held horizontally, and FIG. 13B depicts a panoramic-photography recommendation screen when the image capture apparatus is held vertically;

FIG. 14 illustrates a table in which recognized scenes and sample panoramic images are associated with each other;

FIG. 15 is a block diagram illustrating an overall configuration of an image capture apparatus according to a second embodiment of the present technology;

FIGS. 16A, 16B, and 16C illustrate a third example of the degree of connection; and

FIG. 17 is a block diagram illustrating the configuration of an image capture apparatus according to a modification of the present technology.

### DETAILED DESCRIPTION OF EMBODIMENTS

Embodiments of the present technology will be described below with reference to the accompanying drawings. A description will be given in the following order:

### <1. First Embodiment>

### [1-1. Configuration of Image Capture Apparatus]

### [1-2. Processing by Image Capture Apparatus]

### <2. Second Embodiment>

### [2-1. Configuration of Image Capture Apparatus]

### [2-2. Processing by Image Capture Apparatus]

### <3. Modifications>

### 1. First Embodiment

[1-1. Configuration of Image Capture. Apparatus]

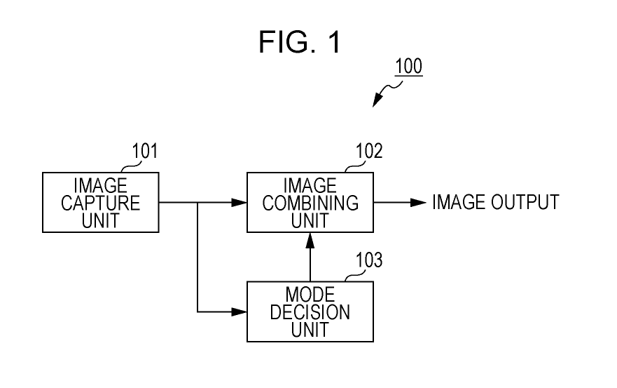

A description will be given of the configuration of an image capture apparatus 100 according to a first embodiment. First, a general configuration of the image capture apparatus 100 will be described with reference to FIG. 1. The image capture apparatus 100 includes an image capture unit 101, an image combining unit 102, and a mode decision unit 103.

The image capture unit 101 includes an image capture device, a circuit for reading an image signal from the image capture device, and so on. The image capture device performs photoelectric conversion on incident light to convert the incident light from a subject into electrical charge and outputs the electrical, charge as image data. The image capture device is implemented by a charge-coupled device (CCD), a complementary metal-oxide semiconductor (CMOS), or the like.

The image combining unit 102 connects and combines a plurality of images, acquired by the image capture unit 101, to generate an image having a size that is greater than or equal to an angle of view of the image capture apparatus 100 and outputs the generated image. The generated image is compressed by, for example, a predetermined compression system, such as a Joint Photographic Experts Group (JPEG) system.

The “image having a size that is greater than or equal to the angle of view” refers to, for example, a panoramic image acquired by a photography technique for performing photography by drawing a trace. The present technology will be described below in conjunction with an example of a case in which an image having a size that is greater than or equal to the angle of view is a panoramic image. The panoramic photography involves performing photography while horizontally or vertically sweeping the image capture apparatus 100 with a constant speed, acquiring a large number of images through high-speed continuous shooting, and connecting the large number of images together to generate a panoramic image.

The mode decision unit 103 decides whether or not generating a panoramic image by using the image combining unit 102 is optimum. Details of processing performed by the mode decision unit 103 are described later.

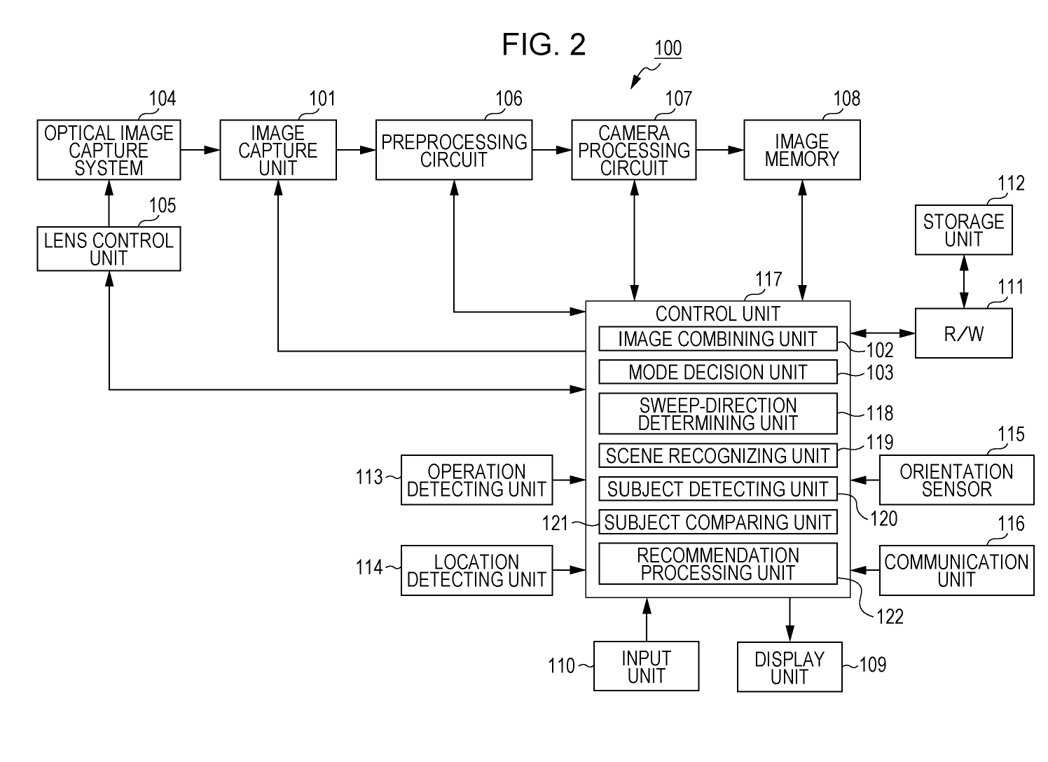

Now, a description will be given of an overall configuration of the image capture apparatus 100 according to the present embodiment. FIG. 2 is a block diagram illustrating an overall configuration of the image capture apparatus 100.

The image capture apparatus 100 includes an optical image capture system 104, a lens control unit 105, a preprocessing circuit 106, a camera processing circuit 107, an image memory 108, a display unit 109, an input unit 110, a reader/writer (R/W) 111, a storage unit 112, an operation detecting unit 113, a location detecting unit 114, an orientation sensor 115, a communication unit 116, and a control unit 117. The control unit 117 serves as the image combining unit 102, the mode decision unit 103, sweep-direction determining unit 118, a scene recognizing unit 119, a subject detecting unit 120, a subject comparing unit 121, and a recommendation processing unit 122.

The optical image capture system 104 includes a photography lens that focuses light from a subject onto the image capture device, as well as a drive mechanism, a shutter mechanism, and an iris mechanism which move the photography lens to perform focus adjustment and zooming, and so on. These mechanisms are driven on the basis of a control signal from the lens control unit 105. The optical image capture system 104 obtains an optical image of the subject, and the optical image is formed on the image capture device of the image capture unit 101.

The lens control unit 105 is, for example, an in-lens microcomputer, and controls operations of the drive mechanism, the shutter mechanism, the iris mechanism, and so on in the optical image capture system 104 in accordance with control performed by the control unit 117.

The image capture unit 101 is the same as or similar to that described above with reference to FIG. 1, and performs photoelectric conversion to convert incident light from a subject into electrical charge and outputs the electrical charge as an image signal. The output image signal is then supplied to the preprocessing circuit 106. The image capture device is implemented by a CCD, CMOS, or the like.

The preprocessing circuit 106 performs correlated double sampling (CDS) processing on a captured-image signal output from the image capture device, to perform sample and hold and so on so as to maintain a signal-to-noise (S/N) ratio at a favorable level. In addition, the preprocessing circuit 106 performs auto gain control (AUC) processing to control a gain, performs analog-to-digital (A/D) conversion, and output a resulting digital image signal.

The camera processing circuit 107 performs signal processing on the image signal from the preprocessing circuit 106. Examples of the signal processing include white-balance adjustment processing, color correction processing, gamma correction processing, luminance/color (Y/C) conversion processing, and auto exposure (AE) processing.

The image memory 108 serves as a buffer memory implemented by a volatile memory, for example, a dynamic random access memory (DRAM), and temporarily stores image data on which predetermined processing has been performed by the preprocessing circuit 106 and the camera processing circuit 107. In the present embodiment, mode decision processing is performed based on an image generated by the image capture unit 101 and stored in the image memory 108 (i.e., an image before it is eventually stored in the storage unit 112 as a photographed image).

The display unit 109 serves as display means including, for example, a liquid-crystal display (LCD), a plasma display panel (PDP), or an organic electroluminescent (EL) panel. The display unit 109 displays a live-view image being captured, a photographed image recorded in the storage unit 112, and so on.

The input unit 110 includes, for example, a power button for power-on/off switching, a release button for giving an instruction for starting recording of a captured image, an operation key for zoom adjustment, and a touch screen integrally configured with the display unit 109. When input is performed on the input unit 110, a control signal corresponding to the input is generated and is output to the control unit 117. The control unit 117 then performs computational, processing and control corresponding to the control signal.

The R/W 111 is an interface to which the storage unit 112 to which photographed images and so on are recorded is coupled. The R/W 111 writes data, supplied from the control unit 117, to the storage unit 112 and also outputs data, read from the storage unit 112, Co the control unit 117.

The storage unit 112 is, for example, a mass storage medium, such as hard disk, a Memory Stick (a registered trademark of Sony Corporation), or secure digital (SD) memory card. Images are stored in compressed state, based on a standard, such as a JPEG standard. Exchangeable image file format (Exif) data including information about the stored images and additional information, such as date and time of the photography, are also stored in association with the images.

The operation detecting unit 113 includes an acceleration sensor, a gyro-sensor, an electronic spirit level, and so on. By measuring the acceleration, movement, tilt, and so on of the image capture apparatus 100, the operation detecting unit 113 detects, for example, the amount and the direction of movement of the image capture apparatus 100 resulting from a user operation. The information detected by the operation detecting unit 113 is supplied to the image combining unit 102 and the mode decision unit 103.

The location detecting unit 114 includes a reception device for a global positioning system (GPS). The location detecting unit 114 detects the current location of the image capture apparatus 100 on the basis of orbit data and distance data (which indicates distances between GPS satellites and the image capture apparatus 100), the data being obtained by receiving GPS radio waves from the GPS satellites and performing predetermined processing on the GPS radio waves. The detected current location is supplied to the control unit 117 as current-location information.

The orientation sensor 115 is, for example, a sensor for detecting an orientation on the earth by utilizing geomagnetism. The detected orientation is supplied to the control unit 117 as orientation information. The orientation sensor 115 is, for example, a magnetic field sensor having a coil with two mutually orthogonal axes and an electrical resistance device disposed at a center portion of the coil. The location information detected by the location detecting unit 114 and the orientation information detected by the orientation sensor 115 can also be stored as Exif data in association with the images.

The control unit 117 incudes, for example, a central processing unit (CPU), a random access memory (RAM), and a read only memory (ROM). The ROM stores therein, for example, programs read into the CPU for operation. The RAM is used as a work memory for the CPU. The CPU controls the entire image capture apparatus 100 by executing various types of processing and issuing commands in accordance with the programs stored in the ROM.

By executing a predetermined program, the control unit 117 also serves as the image combining unit 102, the mode decision unit 103, the sweep-direction determining unit 118, the scene recognizing unit 119, the subject detecting unit 120, the subject comparing unit 121, and the recommendation processing unit 122. These units, however, are not only implemented by the program, but may also be implemented by a combination of dedicated hardware devices having the corresponding functions.

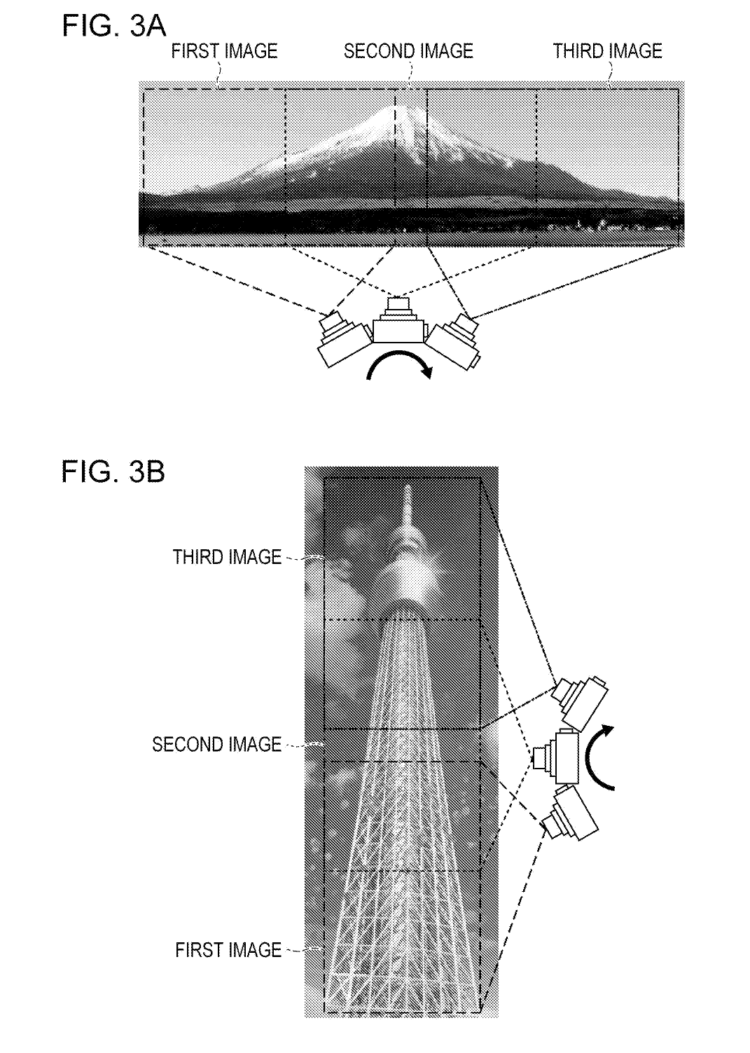

For example, on the basis of the amount and the direction of movement of the image capture apparatus 100 which are detected by the operation detecting unit 113, the image combining unit 102 connects and combines a plurality of continuous images, acquired by the image capture unit 101 and stored in the image memory 108, to generate a panoramic image, which is an image having a size that is greater than or equal to the angle of view, as illustrated in FIGS. 3A and 3B. Although the image combining unit 102 combines three images to generate one panoramic image in the example in FIGS. 3A and 3B, this is merely exemplary for convenience of description, and the number of images is not limited thereto. Typically, a larger number of images are used to generate a panoramic image. The generated panoramic image is compressed by, for example, a predetermined compression system, such as a JPEG system, and the compressed panoramic image is stored in the storage unit 112. When the image capture apparatus 100 is in a mode for acquiring a panoramic image (this mode is hereinafter referred to as a “panoramic photography mode”), the image combining unit 102 generates a panoramic image.

On the basis of the detection information from the operation detecting unit 113 and generated images, the mode decision unit 103 decides whether or not generating a panoramic image in the panoramic photography mode is optimum. Depending upon a result of the decision made by the mode decision unit 103, the image capture apparatus 100 operates in the panoramic photography mode. When the mode decision unit 103 decides that the panoramic photography mode is optimum and the image capture apparatus 100 is operating in the panoramic photography mode, the image combining unit 102 performs image combining processing. Details of processing performed by the mode decision unit 103 are described later.

The sweep-direction determining unit 118 determines an appropriate direction of sweep of the image capture apparatus 100 during panoramic photography. The panoramic photography involves performing photography while horizontally or vertically sweeping the image capture apparatus 100 with a constant speed, acquiring a large number of images through high-speed continuous shooting, and connecting the images together to generate a panoramic image. For example, when the acceleration sensor in the operation detecting unit 113 detects that the user is vertically sweeping the image capture apparatus 100, the sweep-direction determining unit 118 determines that the direction of sweep of the image capture apparatus 100 is “vertical”. On the other hand, for example, when the operation detecting unit 113 detects that the user is horizontally sweeping the image capture apparatus 100, the sweep-direction determining unit 118 determines that the direction of sweep is “horizontal”.

The sweep-direction determining unit 118 may also determine the direction of sweep on the basis of a type of subject detected by the subject detecting unit 120. For example, when the subject detected by the subject detecting unit 120 is a vertically long subject, the sweep-direction determining unit 118 determines that the direction of sweep is “vertical”. On the other hand, when the subject detected by the subject detecting unit 120 is a horizontally long subject, the sweep-direction determining unit 118 determines that the direction of sweep is “horizontal”.

The direction of sweep may be determined based on either the movement of the image capture apparatus 100 or the type of subject or may also be determined based on the both. When the direction of sweep is determined based on the both, the direction of sweep can presumably be determined with greater precision.

The scene recognizing unit 119 recognizes a scene in an image on the basis of color saturation information and brightness information in the image, as well as various types of information, such as a face-detection result and an edge-detection result. Examples of the scene recognized include a landscape view, a beach scene (sea scenery), a snow scene (snowy scenery), and a night view. The recommendation processing unit 122 uses a result of the recognition, performed by the scene recognizing unit 119, to recommend a photography mode.

For example, the scene recognizing unit 119 recognizes the scene as a landscape view, when the brightness is higher than a predetermined threshold, and recognizes the scene as a night view, when the brightness is lower than or equal to the predetermined threshold. By detecting a specific subject through template matching or the like, the scene recognizing unit 119 can also recognize a scene in which a specific subject is present. A method for the scene recognition is not limited to the particular method and may be implemented by any type of scene recognition method.

The subject detecting unit 120 detects a subject shown in a live-view image, for example, by using pattern matching or a currently available subject-detection technique utilizing color information, brightness information, or the like.

The subject comparing unit 121 compares the subjected detected by the subject detecting unit 120 with a recommended panoramic subject. The recommended panoramic subject is described later. The subject comparing unit 121 performs the subject comparison by pattern matching or the like.

The recommendation processing unit 122 performs processing for recommending an optimum photography mode, derived by the decision made by the mode decision unit 103, to the user. Examples of a scheme for recommending the photography mode include displaying on the display unit 109. Details of processing performed by the recommendation processing unit 122 are described later.

The RUM in the control unit 117 stores therein recommended-panoramic-subject information and sample-panoramic-image information. The recommended-panoramic-subject information is information in which images of specific subjects and location information of the subjects are associated with each other. Examples of the specific subjects include buildings, such as Tokyo Skytree, Tokyo Tower, Roppongi Hills, and the Rainbow Bridge, and landscape views, such as Mount Fuji. The recommended panoramic subject is subject that is vertically or horizontally long and that is suitable for photography in the panoramic photography mode. The location information is, for example, latitude and longitude information.

When the recommendation processing unit 122 recommends the panoramic photography mode, a sample panoramic image is displayed to show, to the user, how an image that can be photographed in toe panoramic photography mode will look. Details of use of the sample panoramic image are described later. The recommended-panoramic-subject information and the sample-panoramic-image information may also be stored in the storage unit 112, not in the RUM in the control unit 117.

The communication unit 116 is, for example, a network interface for communicating with networks, such as the Internet and a dedicated network, in accordance with a predetermined protocol. A communication system of the communication unit 116 may be any system for wired communication or communication using a wireless local area network (LAN), Wireless Fidelity (Wi-Fi) link, a third generation (3G) mobile telecommunication network, a fourth generation (4G) mobile telecommunication network, Long Term Evolution (LIE) network, or the like. The image capture apparatus 100 receives, via the communication unit 116, the recommended-panoramic-subject information, the sample-panoramic-image information, and so on from, for example, a server at a vendor that supplies the image capture apparatus. Thus, even when a new building, a sightseeing spot, or the like is created, information thereabout can accordingly be added to the image capture apparatus 100.

The image capture apparatus 100 is configured as described above. The processing performed by the image capture apparatus 100 can be executed by hardware or software. When the processing is executed by software, a program in which a processing sequence is recorded is installed to the memory in the control unit 117 in the image capture apparatus 100 for execution.

For example, the program can be pre-recorded to recording media such as a hard disk and a ROM. Alternatively, the program can be pre-recorded to recording media, such as a compact disc read only memory (CD-ROM), a digital versatile disc (DVD), and a semiconductor memory. Such recording media can be supplied in the form of packaged software. The user installs the packaged software to the image capture apparatus 100.

The program may be not only a program installed from a recording medium as described above to the image capture apparatus 100 but also be a program provided on the Internet and transferred as an application program to the image capture apparatus 100 for installation.

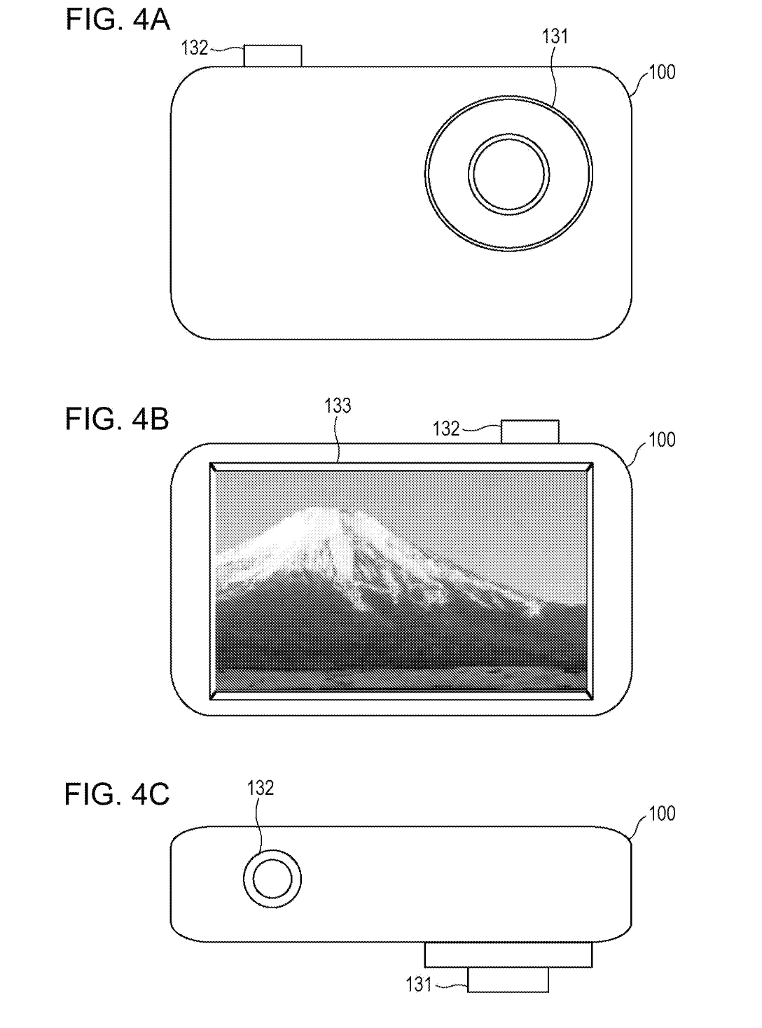

Next, an external configuration of the image capture apparatus 100 will be described with reference to FIGS. 4A to 4C. FIGS. 4A to 4C are schematic views illustrating one example of the external configuration of the image capture apparatus 100 according to an embodiment of the present technology. FIG. 4A is a front view, FIG. 4B is a back view, and FIG. 4C is top view. In the example illustrated in FIGS. 1A to 4C, the image capture apparatus 100 is formed to have a low-profile, horizontally long, generally cuboid shape.

The image capture apparatus 100 has an image capture lens 131 at a front surface thereof. The image capture apparatus 100 has, at a top surface thereof, a release button 132 that the user presses or operates to perform image capture. The release button 132 serves as input means for issuing an auto-focus instruction, inputting a release instruction, and inputting other instructions. For example, when the release button 132 is pressed halfway down (half press), a detection instruction is input, and when the release button 132 is pressed all the way down (full press), a release instruction is input. The release button 132 is included in the input unit 110 in the block diagram illustrated in FIG. 2.

The image capture apparatus 100 has a display 133 at a back surface thereof. The display 133 corresponds to the display unit 109 in the block diagram illustrated in FIG. 2 and serves as display means, such as an LCD, a PDP, or an organic EL panel. The display 133 displays live-view images, images acquired by image capture, user interfaces, various setup screens, and so on.

In the image capture apparatus 100 according to the embodiment of the present technology, a message for recommending she panoramic photography mode to the user, a software button on which the user performs an input to select the panoramic photography mode, and a sample panoramic image are displayed on the display 133 in a manner superimposed on a live-view image.

The image capture apparatus 100 also has, at the back surface thereof, a touch panel integrally configured with the display 133. The touch panel is, for example, a capacitive touch panel or a pressure-sensitive touch panel. The touch panel serves as input means with which the user can perform various inputs on the image capture apparatus 100 by touching with his or her finger. The touch panel is included in the input unit 110 in the block diagram illustrated in FIG. 2. The touch panel, however, may or may not be provided. When the touch panel is not provided, the image capture apparatus is instead provided with a hardware button.

The touch panel can detect individual operations simultaneously performed on a plurality of spots on an operating surface and can output coordinate data indicating the respective touched positions. The touch panel, can also detect individual operations repeatedly performed on the operating surface and can output coordinate data indicating the respective touched positions.

The image capture apparatus also has an insertion slot for a battery, an insertion slot for a medium for recording images, and a connection port (not illustrated) for a Universal Serial Bus (USB) terminal. These slots and port are typically covered by a protection cover that can be opened and closed, and thus are not visible from outside. The protection cover is opened during insertion/removal of the battery or the recording medium.

The external appearance of the image capture apparatus 100 is not limited to the example described above and may take any form having the functions of the image capture apparatus 100. The present technology is also applicable to not only the image capture apparatus 100 but also any implementations having functions of the image capture apparatus 100. Examples include mobile phones, smartphones, tablet terminals, and video cameras.

### [1-2. Processing by Image Capture Apparatus]

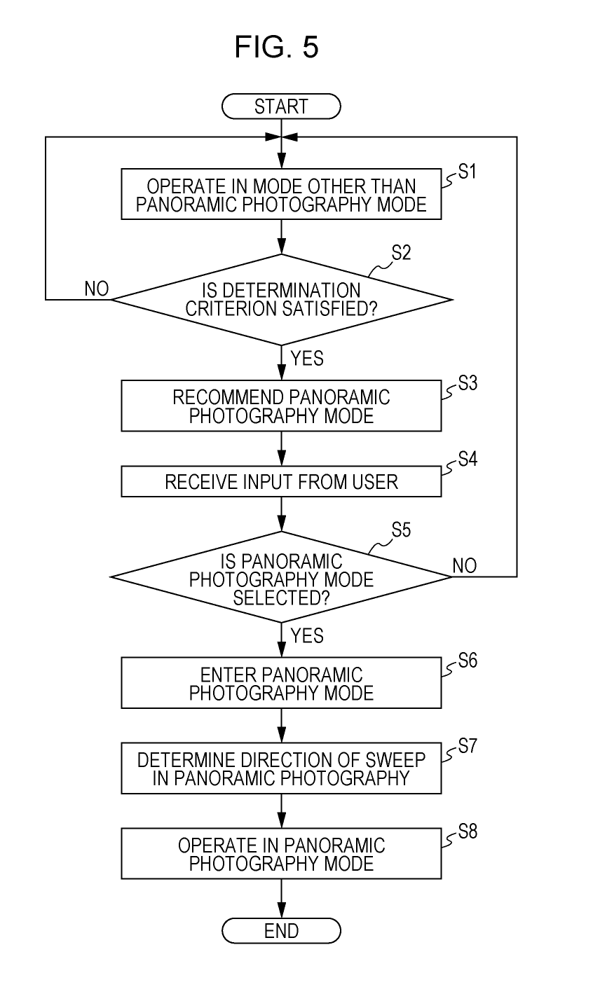

Next, a description will be given of processing performed by the image capture apparatus 100. FIG. 5 illustrates an overall flow of the processing performed by the image capture apparatus 100. As a premise, it is assumed the image capture apparatus 100 has been started up and is ready to perform photography. First, in step S1, the image capture apparatus 100 is operating in a mode other than the panoramic photography mode and thus can perform ordinary photography.

Next, in step S2, a decision is made as to whether or not a determination criterion for determining whether or not the panoramic photography mode is an optimum photography mode is satisfied. The decision as to whether or not the determination criterion is satisfied is descried later. When the determination criterion is not satisfied (NO in step S2), the process returns to step S1. Then, the decision in step S2 is repeated, while the image capture apparatus 100 is operation in a mode other than the panoramic photography mode.

On the other hand, when the determination criterion is satisfied (YES in step S2), the process proceeds from step S2 to step S3. In step S3, under the control of the recommendation processing unit 122, a notification indicating that the panoramic photography mode is an optimum photograph mode is issued to the user to thereby recommend the panoramic photography mode. The recommendation of the panoramic photography mode to the user is described later.

In step S4, the input unit 110 receives an input from the user. This input is an input from the user who has received the recommendation of the panoramic photography mode via a panoramic-photography recommendation screen and is indicative of whether or not panoramic photography is to be performed.

In step S5, it is checked whether or not the user selects the panoramic photography mode. When the user does not select the panoramic photography mode (NO in step S5), the process returns to step S1.

On the other hand, when the user selects the panoramic photography mode (YES in step S5), the process proceeds to step S6. In step S6, the control unit 117 causes the image capture apparatus 100 to enter the panoramic photography mode.

Next, in step S7, the sweep-direction determining unit 118 determines the direction of sweep in the panoramic photography. For example, when the acceleration sensor detects that the user is vertically sweeping the image capture apparatus 100, the sweep-direction determining unit 118 determines that the direction of sweep for the panoramic photography is “vertical” on the basis of a result of the detection. On the other hand, when the acceleration sensor detects that the user is horizontally sweeping the image capture apparatus 100, the sweep-direction determining unit 118 determines that the direction of sweep is “horizontal”.

The sweep-direction determining unit 118 may also determine the direction of sweep on the basis of the type of subject detected by the subject detecting unit 120. For example, when the subject detected by the subject detecting unit 120 is a vertically long subject, the sweep-direction determining unit 118 may determine that the direction of sweep is “vertical”. On the other hand, when the subject detected by the subject detecting unit 120 is a horizontally long subject, the sweep-direction determining unit 118 may determine that the direction of sweep is “horizontal”.

When the direction of sweep has been determined in step S7, the process proceeds to step S8 in which the image capture apparatus 100 operates in the panoramic photography mode. For example, the image capture apparatus 100 operates so to perform a so-called sweep panorama photography.

The “sweep panorama” involves performing photography while sweeping the image capture apparatus 100 in a certain direction, acquiring a large number of images through high-speed continuous shooting, and connecting and combining the large number of images with high accuracy to thereby generate a panoramic image. The combination of the images is performed by the image combining unit 102.

The overall flow is performed as described above.

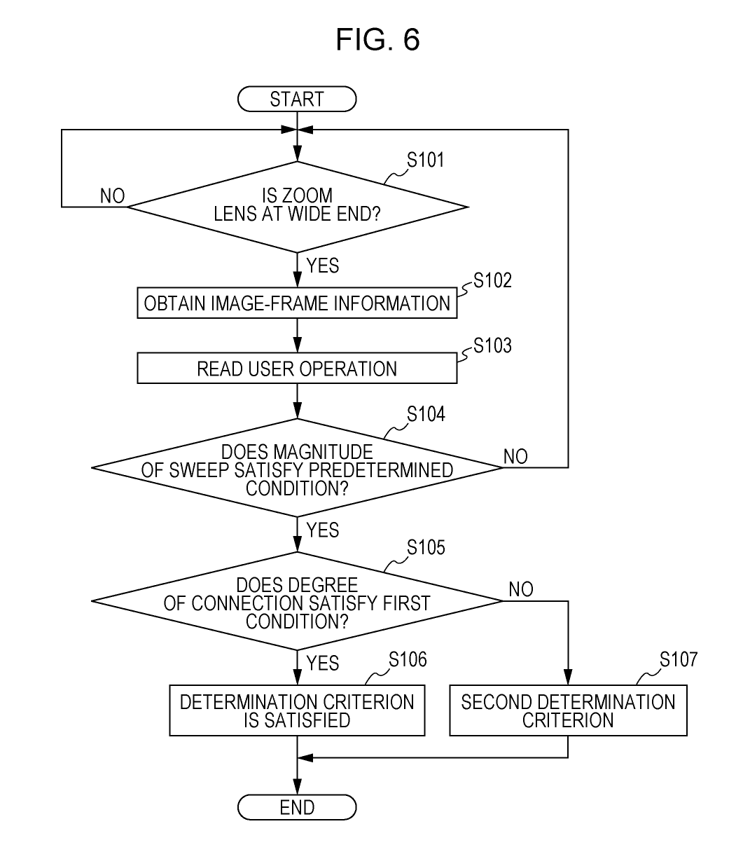

Next, the determination criterion for determining whether or not the panoramic photography is appropriate will be described with reference to the flowcharts in FIGS. 6, 9, and 10. The decision as to whether or not the determination criterion is satisfied is made by the mode decision unit 103. A first determination criterion will first be described with reference to the flowchart in FIG. 6.

First, in step S101, it is checked whether or not a zoom lens of the optical image capture system 104 is at its wide end (wide-angle end). Since the lens control unit 105 controls the operation of the zoom lens in accordance with a control signal from the control unit 117, it is possible to check the operation of the zoom lens by obtaining the control signal, information from the lens control unit 105, or the like.

In step S102, image-frame information indicating the size of an image frame is obtained. The “image frame” refers to an entire area captured through an effective area of the image capture device or a slightly smaller area than the entire area. The image-frame information can be obtained, for example, by referring to information pre-stored in the control unit 117 or the like.

In step S103, an operation of the image capture apparatus 100 performed by the user is read. The operation of the image capture apparatus 100 performed by the user is an operation of sweeping it horizontally or vertically in order to check whether or not a subject fits in the image frame or in order to check which subject is to be photographed. The user-operation reading is performed by obtaining a detection result from the operation detecting unit 113, which includes an acceleration sensor, an electronic spirit level, and so on.

In step S104, a decision is made as to whether or not the magnitude of sweep of the image capture apparatus 100 performed by the user satisfies a predetermined condition. The predetermined condition is that the magnitude of sweep is at least one and a half times greater than the image frame. The decision is made, for example, by confirming that, during the sweeping operation of the image capture apparatus 100, the magnitude of sweep is at least one and a half times greater than the image frame size with reference to the image frame size at the start of sweeping the image capture apparatus 100. The value “one and a half times” is merely an exemplary value, and thus the predetermined condition is not limited thereto.

When the magnitude of sweep does not satisfy the predetermined condition (NO in step S104), the process returns to step S101. On the other hand, when the magnitude of sweep satisfies the predetermined condition (YES in step S104), the process proceeds to step S105.

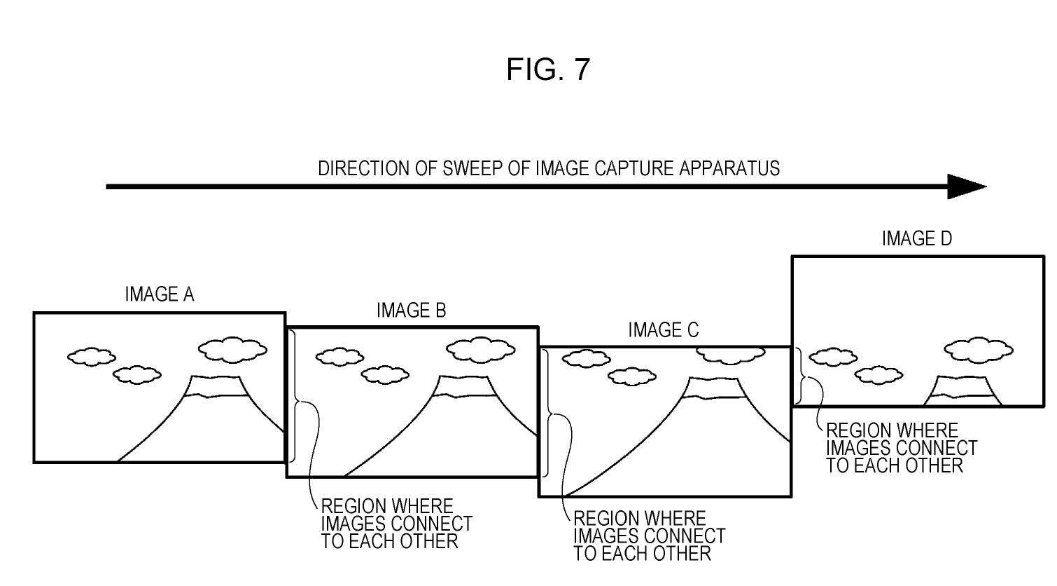

In step S105, a decision is made to whether or not the degree of connection of images satisfies a first condition. The expression “degree of connection” refers to a degree of connection of adjacent images of the images acquired through high-speed continuous shooting. A first example of the degree of connection is the degree so which images connect to each other (i.e., how small a displacement between images is) in the height direction (when the user horizontally sweeps the image capture apparatus 100) or the degree to which images connect to each other in the width direction (when the user vertically sweeps the image capture apparatus 100). This point will now be described with reference to FIG. 7.

Four images A to D illustrated in FIG. 7 represent images acquired through high-speed continuous shooting while the user horizontally sweeps the image capture apparatus 100. A vertical displacement between the image A, which is the first image, and the image B, which is the second image, is small, and thus the range where the images A and B connect to each other is large. A vertical displacement between the image B, which is the second image, and the image C, which is the third image, is small, and thus the range where the images B and C connect to each other is large. A vertical displacement between the image C, which is the third image, and the image D, which is the fourth image, is large, and thus the range where the images C and D connect to each other is small.

The range where images connect to each other is defined as the degree of connection. For example, when the degree of connection is 80% or more of the height of an image in question, it is decided that the first condition is satisfied. In FIG. 7, a case in which the image capture apparatus 100 is horizontally swept and the images connect to each other horizontally has been described by way of example. However, when the image capture apparatus 100 is vertically swept, the degree of connection is defined by a horizontal range where images connect to each other.

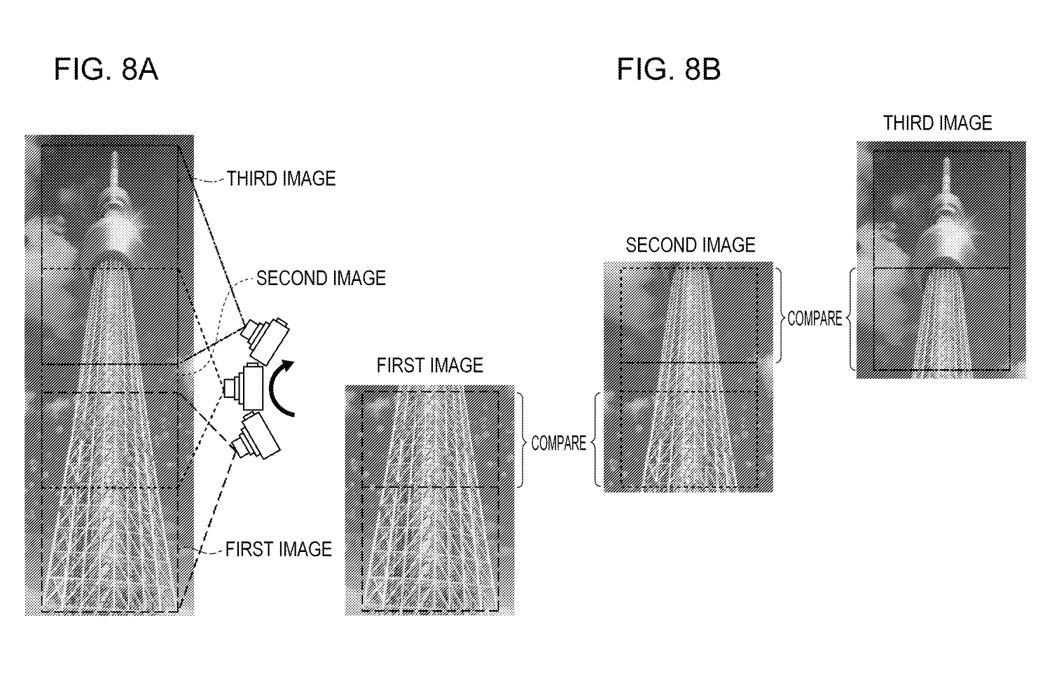

Next, a second example of the degree of connection will be described with reference to FIGS. 8A and 8B. The second example of the degree of connection is a degree of match between subjects in an overlapping range of images sequentially acquired through high-speed continuous shooting.

FIG. 8A depicts an image of a building acquired through high-speed continuous shooting by vertically sweeping the image capture apparatus 100. As illustrated in FIG. 8B, image-matching processing or the like is performed on a range where a first image and a second image overlap each other, to thereby decide whether or not subjects in the images match each other. In addition, for example, a ratio at which an area decided to be a match occupies a range in which the first image and the second image overlap each other is defined as the degree of connection. For example, when the area determined to be a match occupies 80% of the range in which the first image and the second image overlap each other, it is determined that the degree of connection is 80%.

Similarly, as illustrated in FIG. 8B, image-matching processing or the like is performed on a range where the second image and a third image overlap each other, to thereby determine whether or not the subjects therein match each other.

For example, when this processing is performed on all adjacent images and all of the degrees of connection are 80% or more, it is determined that the degree of connection is 80% or more. Also, when the processing is performed on all adjacent images and the average of the degrees of connection exceeds 80%, it may be determined that the degree of connection is 80% or more.

Rather than performing the processing on all images, the processing may also be performed on a predetermined number of images for generating a panoramic image, to determine the degree of connection. In such a case, there is an advantage in that the panoramic photography mode can be recommended while the user sweeps the image capture apparatus 100 and considers the composition and the subject.

Now, a description will be given with reference back to the flowchart in FIG. 6. When the degree of connection satisfies the first condition (YES in step S105), the process proceeds to step S106. In step S106, processing is performed assuming that the determination criterion is satisfied.

On the other hand, when the degree of connection does not satisfy the first condition (NO in step S105), the process proceeds to step S107. In step S107, it is checked whether or not a second determination criterion is satisfied.

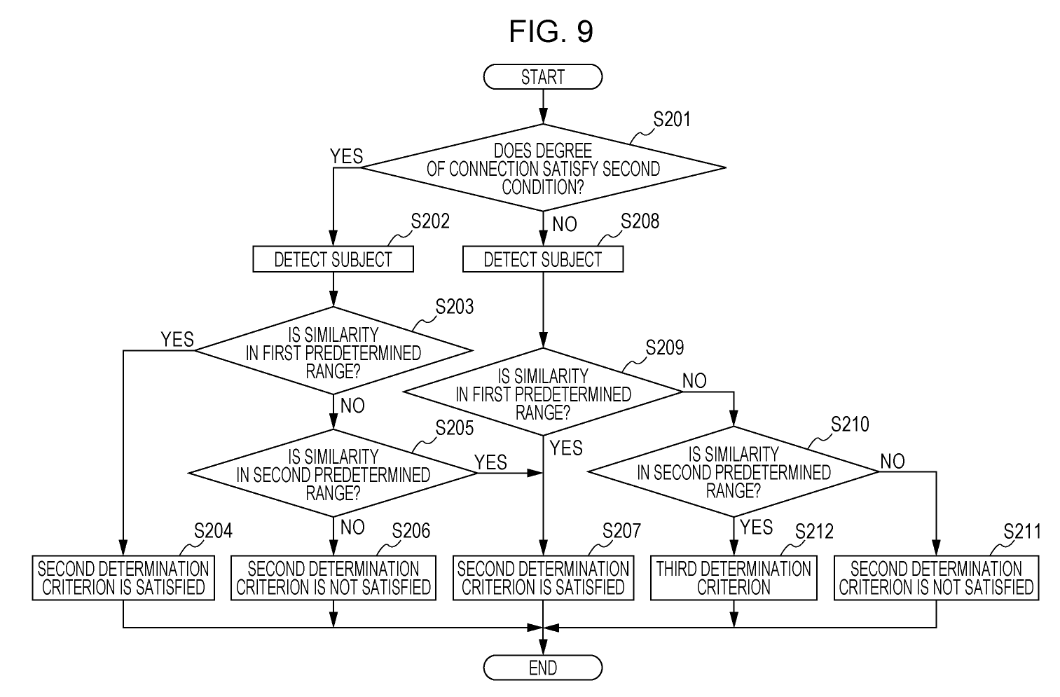

Next, the second determination criterion will be described with reference to the flowchart in FIG. 9. The second determination criterion is a criterion used for decision when the first determination criterion is not satisfied. It is also important that, in the second determination criterion, the zoom lens of the optical image capture system 104 be at its wide end (wide-angle end) and the magnitude of sweep of the image capture apparatus 100 performed by the user satisfy a predetermined condition, as in the first determination criterion.

First, in step S201, a decision is made as to whether or not the degree of connection satisfies a second condition. The degree of connection is analogous to that described above. The second condition is, for example, “50%≦degree of connection <80%”. However, the values in the second condition are merely exemplary and are not limited thereto.

When the degree of connection satisfies the second condition (YES in step S201), the process proceeds to step S202 in which the subject detecting unit 120 performs subject detection processing.

Next, in step S203, the subject comparing unit 121 compares a subject detected by the subject detecting unit 120 with a recommended panoramic subject. For example, the subject comparing unit 121 performs the subject comparison by performing pattern matching or the like.

When the result of the subject comparison performed in step S203 indicates that a similarity between the detected subject and the recommended panoramic subject is in a first predetermined range (YES in step S203), the process proceeds to step S204. The first predetermined range is, for example, a range represented by “similarity≧80%”. The range represented by “similarity≧80%” corresponds to a case in which, when the subject comparison is performed by pattern matching, an area determined to be a match by the pattern matching is 80% or more of the area of the entire subject. However, the first predetermined range is not limited to that value.

In step S204, processing is performed assuming that the second determination criterion is satisfied.

On the other hand, when the similarity is not in the first predetermined range in step S203 (NC) in step S203), the process proceeds to step S205. In step S205, a decision is made as to whether or not the similarity between the subjects is in a second predetermined range. The second predetermined range is a range whose values are smaller than that in the first predetermined range and is represented, by, for example, “50%≦similarity <80%”. However, the second predetermined range is not limited to those values. When the similarity is not in the second predetermined range (NO in step S205), the process proceeds to step S206 in which processing is performed assuming that the second determination criterion is not satisfied.

On the other hand, when the similarity is in the second predetermined range in step S205, the process proceeds to step S207 in which it is decided that the second determination criterion is satisfied.

The description now returns to step S201. When it is decided in step S201 that the degree of connection is not in the second predetermined range (NO in step S201), the process proceeds to step S208. In step S208, the subject detecting unit 120 performs subject detection processing. This processing is the same as or similar to that in step S202.

In step S209, a decision is made as to whether or not the similarity is in a first predetermined range. The first predetermined range is the same as or similar to that in step S203 and is, for example, a range represented by “similarity ≧80%”. When the similarity is in the first predetermined range (YES in step S209), the process proceeds to step S207 in which processing is performed assuming that the second determination criterion is satisfied.

On the other hand, when the similarity is not in the first predetermined range in step S209 (NO in step S209), the process proceeds to step S210. In step S210, a decision is made as to whether or not the similarity between she subjects is in a second predetermined range. When the similarity is not in the second predetermined range (NO in step S210), the process proceeds to step S211 in which processing is performed assuming that the second determination criterion is not satisfied.

On the other hand, when the similarity is in the second predetermined range, the process proceeds to step S212 (NO in step S210) in which a decision is made as to whether or not a third determination criterion is satisfied.

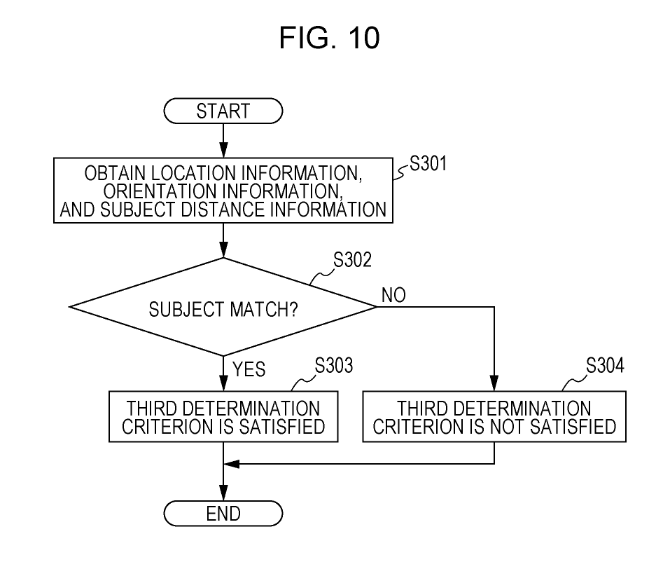

Next, the third determination criterion will be described with reference to the flowchart in FIG. 10. As in the first determination criterion and the second determination criterion, it is also important that, in the third determination criterion, the zoom lens of the optical image capture system 104 be at is wide end (wide-angle end) and the magnitude of sweep of the image capture apparatus 100 performed by the user satisfy a predetermined condition.

First, in step S301, the mode decision unit 103 obtains location information of the image capture apparatus 100 from a detection result of the location detecting unit 114. The mode decision unit 103 also obtains orientation information of the image capture apparatus 100 from a detection result of the orientation sensor 115. The mode decision unit 103 further obtains subject distance information from auto focus (AF) information of the image capture apparatus 100.

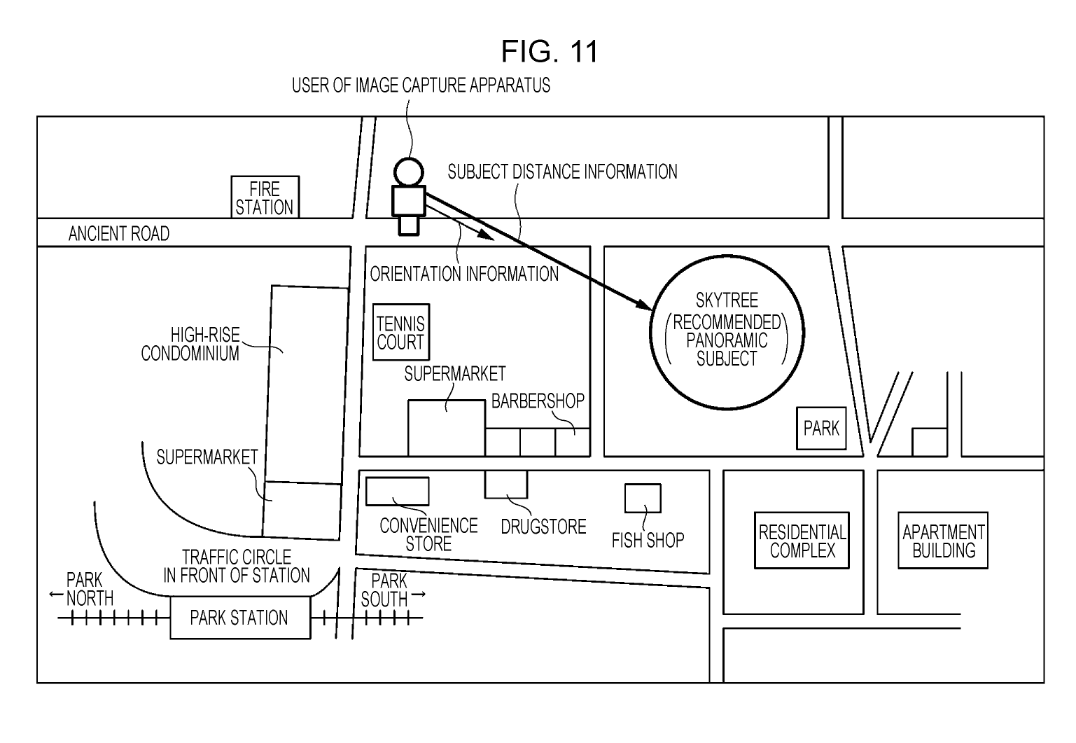

Next, in step S302, on the basis of the location information, the orientation information, and the subject distance information obtained in step S301, a decision is made as to whether or not a subject in the image matches a recommended panoramic subject. This point will be described with reference to FIG. 11.

As described above, in the recommended-panoramic-subject information, the location information represented by latitude and longitude is associated with each subject. Accordingly, use of the location information, the orientation information, and the subject distance information of the image capture apparatus 100 which were obtained in step S301 makes it possible to determine where the user is located, in which direction the image capture apparatus 100 is pointed, and about how far the subject he or she is about to photograph is. Thus, as illustrated in FIG. 11, it is possible to recognize where the subject at which the user is pointing the image capture apparatus 100 is located. By comparing the subject with the recommended-panoramic-subject information, it is possible to decide whether or not a subject in an image matches the recommended panoramic subject.

When the subject matches the recommended panoramic subject (YES in step S302), the process proceeds to step S303 in which processing is performed assuming that the third determination criterion is satisfied. On the other hand, when the subject does not match the recommended panoramic subject (NO in step S302), the process proceeds to step S304 in which processing is performed assuming that the third determination criterion is not satisfied. In this case, none of the first to third determination criteria are satisfied.

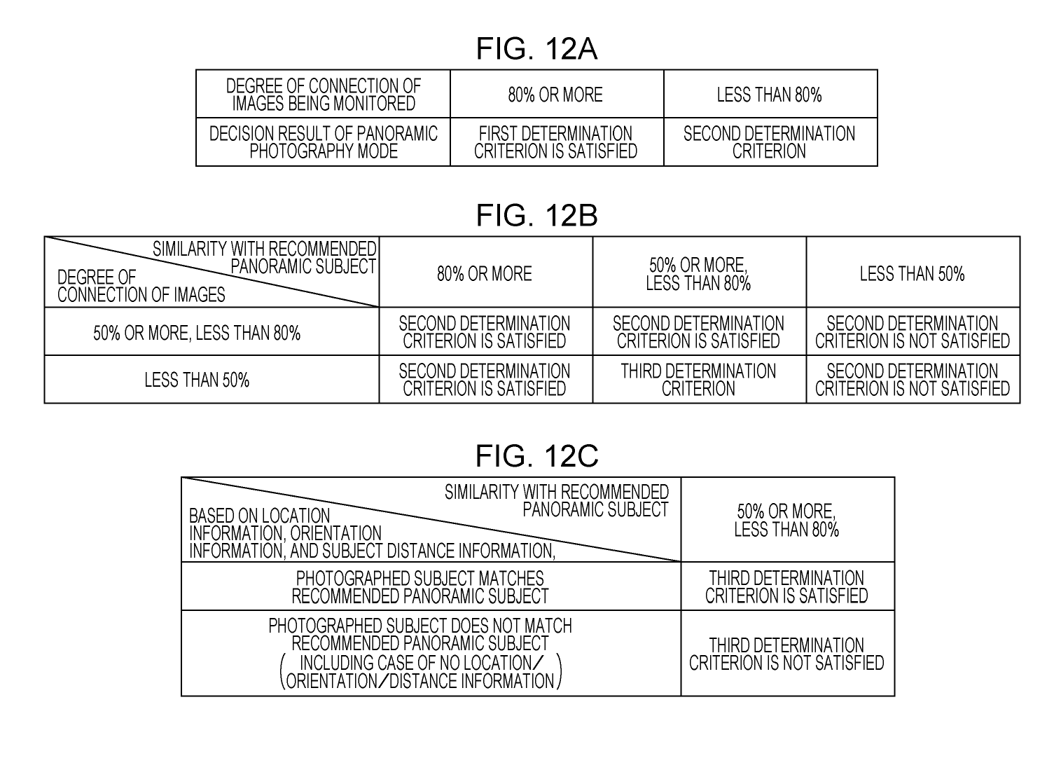

As described above, a decision is made as to whether or not the determination criterion in step S2 in the flowchart illustrated in FIG. 5 is satisfied. FIGS. 12A to 120 illustrate tabularized forms of the first determination criterion, the second determination criterion, and the third determination criterion. FIG. 12A illustrates the first determination criterion, FIG. 12B illustrates the second determination criterion, and FIG. 12C illustrates the third determination criterion.

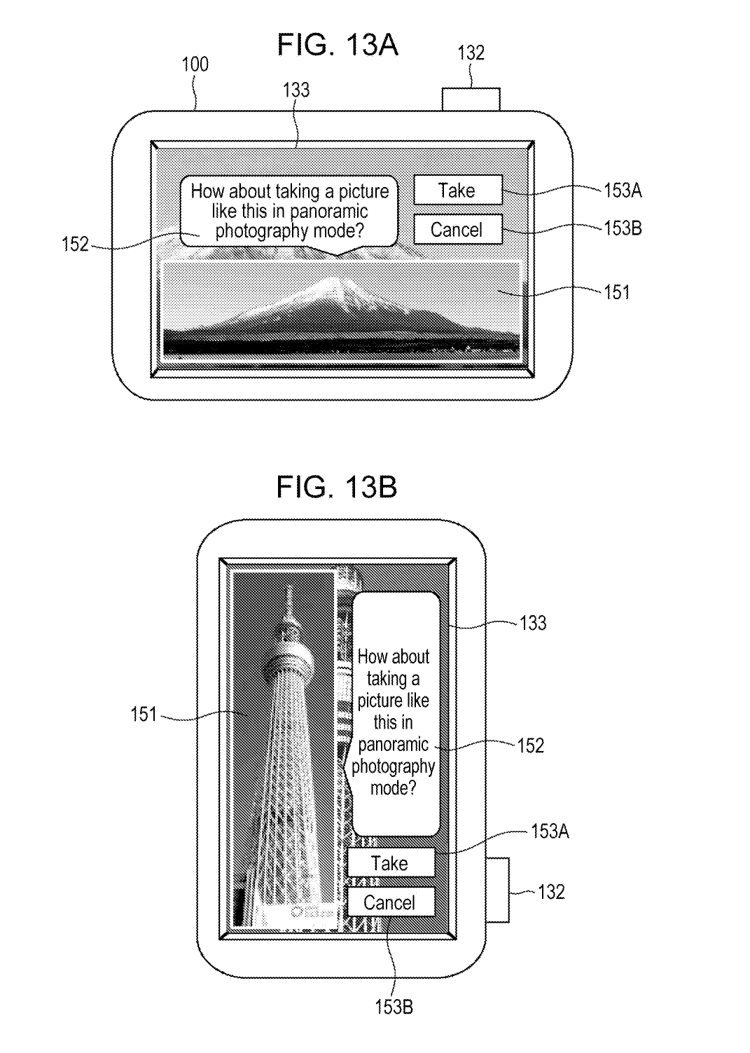

Next, a description will be given of recommending the panoramic photography mode to the user. FIGS. 13A and 13B illustrate specific examples of a screen that is displayed on the display 133 (which corresponds to the display unit 109) of the image capture apparatus 100 in order to recommend the panoramic photography mode (this screen is hereinafter referred to as a “panoramic photography recommendation screen”). The example in FIG. 13A corresponds to a case in which the user holds the image capture apparatus 100 horizontally, and the example in FIG. 13B corresponds to a case in which the user holds the image capture apparatus 100 vertically.

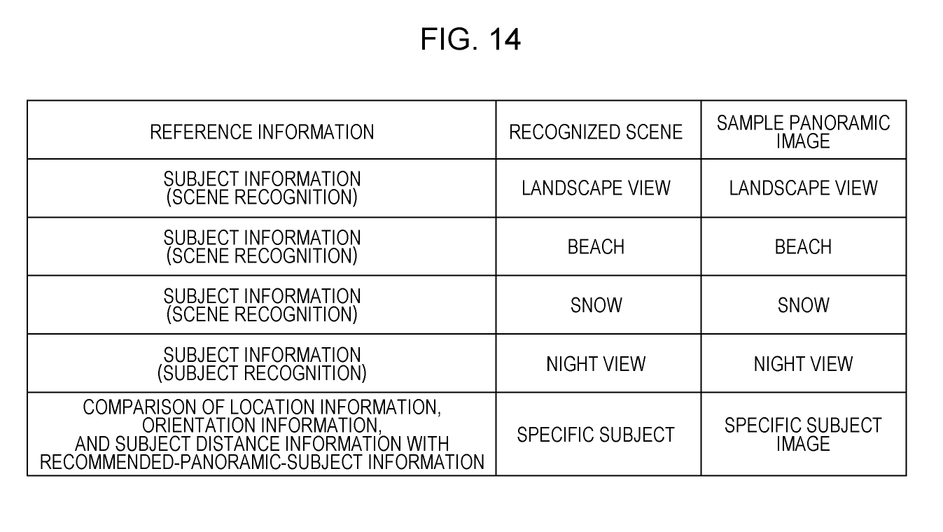

A sample panoramic image 151, a message 152, a “Take” button 153A, and a “Quit” button 153B are displayed on a live-view image on the panoramic-photography recommendation screen. Sample panoramic images are images pre-acquired through panoramic photography and stored in the RUM or the like in the image capture apparatus 100, and are associated in a table as illustrated in FIG. 14.

In the table illustrated in FIG. 14, information used as references for scene recognition, recognition results obtained by the scene recognizing unit 119, and sample panoramic images are associated with each other. On the basis of a recognition result from the scene recognizing unit 119 and with reference to the table in FIG. 14, an image that is the most similar to a recognized scene is selected from the collection of sample panoramic images pre-stored in the image capture apparatus 100 and is displayed as the sample panoramic image on the panoramic-photography recommendation screen.

Thus, since a sample panoramic image photographed in the panoramic photography mode and showing an image that is the most similar to the scene the user is about to photograph is displayed, how an image to be captured in the panoramic photography will look can be presented to the user in a clear and easy-to-comprehend manner.

The message 152 displayed on the panoramic-photography recommendation screen is, for example, a character string for prompting the user to perform panoramic photography. One example of the character string is “How about taking a picture like this in panoramic photography mode?” as illustrated in FIGS. 13A and 13B.

The message 152 may also be displayed in a balloon extending from the sample panoramic image 151. This also makes it possible to inform the user in an easy-to-comprehend manner that the sample panoramic image 151 is an image to be acquired by panoramic photography. However, the contents of the message 152 are not limited to those illustrated in FIGS. 13A and 13B. The contents may be any contents for recommending the panoramic photography mode to the user.

In addition, the “Take” button 153A and the “Cancel” button 153B, which are software button, are displayed on the panoramic-photography recommendation screen. When the display is a touch panel, the user can perform input by touching either of the software buttons 153A and 153B with his or her finger or the like. For performing panoramic photography, the user performs an input on the “Take” button 153A. On the other hand, for not performing panoramic photography, the user performs an input on the “Cancel” button 153B. The shapes of the buttons and the characters illustrated in FIGS. 13A and 13B are examples, and are not limited thereto. The buttons are also not limited to software buttons and may be hardware buttons included in the image capture apparatus 100. When the buttons are hardware buttons, guidance information indicating which button is to be pressed to use the panoramic photography mode may be displayed on the panoramic-photography recommendation screen.

When the image capture apparatus 100 has a speaker, the recommendation of the panoramic photography mode to the user may be performed not only by a display on the display 133 but also sound output from the speaker. For example, a voice message, such as “How about performing photography in panoramic photography mode?”, may be output to prompt the user to use the panoramic photography mode. In addition, for example, how to perform operations in the panoramic photography mode may be guided by voice.

As described above, the image capture apparatus 100 according to the embodiment of the present technology performs the processing. According to the first embodiment of the present technology, a decision is made as to whether or not performing photography in the panoramic photography mode is appropriate, and when performing the photography in the panoramic photography mode is appropriate, a notification to that effect is issued to the user to recommend the panoramic, photography mode to him or her. With this arrangement, for example, a user who does not know about the availability of the panoramic photography mode, a user who does not know how to switch the operation mode to the panoramic photography mode, and a user who does not understand well in what situation the panoramic photography mode is to be used can easily utilize the panoramic photography mode.

### 2. Second Embodiment

### [2-1. Configuration of Image Capture Apparatus]

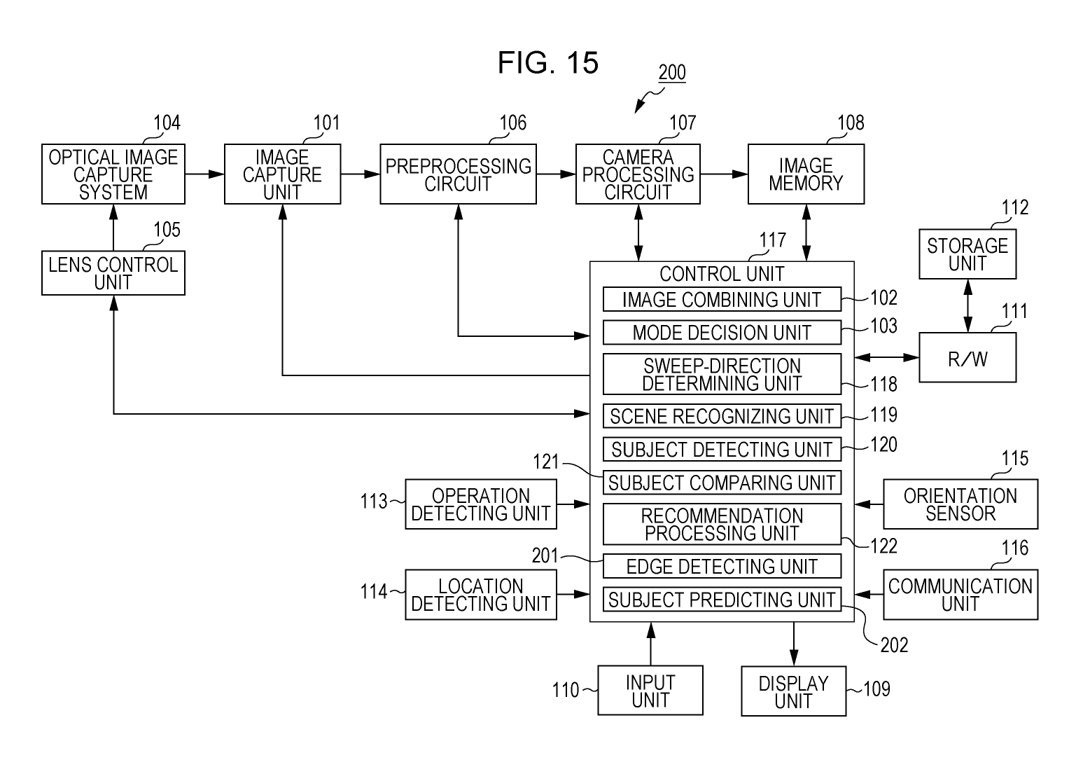

Next, a description will be given of a second embodiment of the present technology. FIG. 15 is a block diagram illustrating the configuration of an image capture apparatus 200 according to the second embodiment. The image capture apparatus 200 according to the second embodiment is different from the image capture apparatus 100 according to the first embodiment in that an edge detecting unit 201 and a subject predicting unit 202 are provided. Since other elements in the image capture apparatus 200 are the same as or similar to those in the image capture apparatus 100 according to the first embodiment, descriptions thereof are not given hereinafter.

In the first embodiment, the degree of connection is determined by comparing adjacent images of a plurality of images acquired through high-speed continuous shooting. The degree of connection, however, may be determined from a single image. The second embodiment is directed to an example in which the degree of connection is determined from a single image.

The edge detecting unit 201 extracts, for example, high-frequency components of image brightness signals, detects an edge portion of an image on the basis of the high frequency components, and outputs a detection result to the subject predicting unit 202.

On the basis of the detection result from the edge detecting unit 201, the subject predicting unit 202 predicts whether or not a subject from which the edge was detected in the image continues to outside of the image frame. The subject predicting unit 202 then outputs a prediction result to the mode decision unit 103. Details of the processing performed by the subject predicting unit 202 are described later. The image capture apparatus 200 according to the second embodiment is configured as described above.

[2-2. Processing by Image Capture Apparatus]

Next, a description will be given of processing performed by the image capture apparatus 200 according to the second embodiment. Flows executed by the image capture apparatus 200 are the same as or similar to those in the first embodiment illustrated in FIGS. 5, 6, 9, and 10. The second embodiment is different from the first embodiment in the scheme for determining the degree of connection.

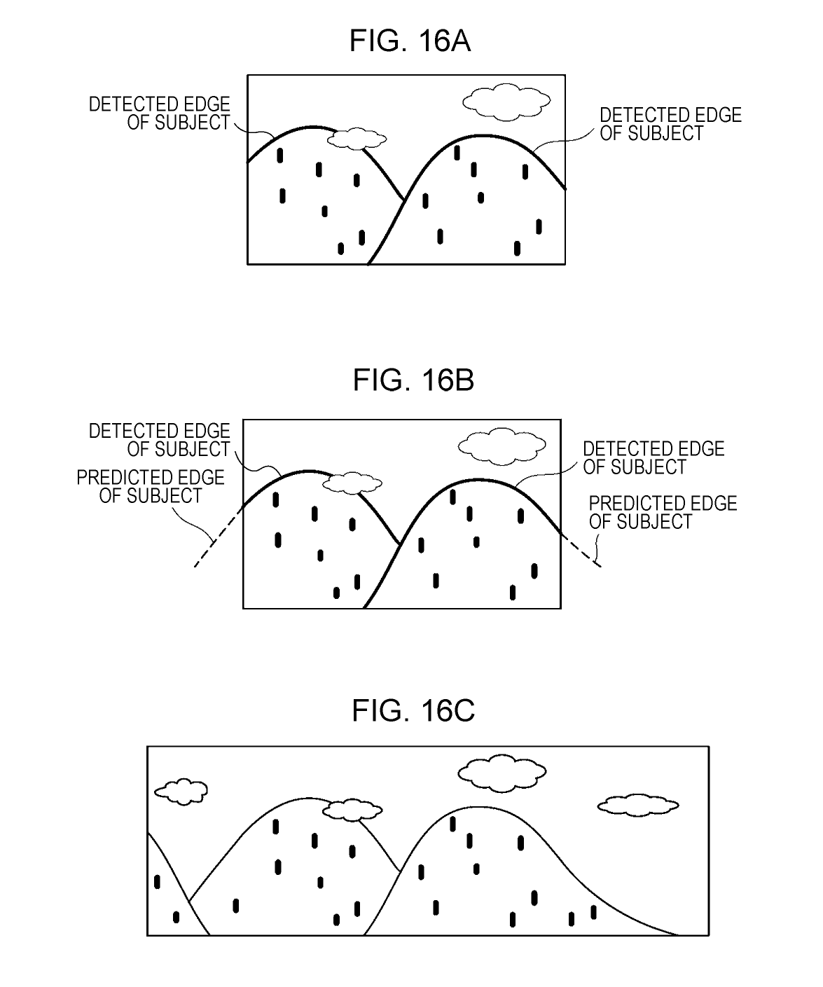

First, the edge detecting unit 201 performs edge detection processing on an image. FIG. 16A depicts one example of the image on which the edge detection is performed. When an edge like a mountain outline denoted by a think line is detected in FIG. 16A and the detected edge crosses the image frame in a manner illustrated in FIG. 16B, the subject predicting unit 202 predicts that the subject in question further continues to outside of the image frame along an extension of the detected edge, as denoted by a dashed line outside the image frame in FIG. 16B.

When the subject predicting unit 202 predicts that the subject continues to outside of the image frame, the mode-decision unit 103 determines that performing photography in the panoramic photography mode is appropriate. When the subject continues to outside of the image frame, performing photography in the panoramic photography mode makes it possible to fit the entire subject within a panoramic image, as depicted in FIG. 16G. Thus, the panoramic photography mode is recommended to the user, or the operation mode of the image capture apparatus 100 is switched to the panoramic photography mode.

As described above, in the second embodiment, it is possible to decide whether or not the panoramic photography mode is an optimum photography mode, without performing processing on a plurality of images.

### 3. Modification

Although the embodiments of the present technology have been specifically described above, the present technology is not limited to the particular embodiments, and various modifications are possible based on the technical idea of the present technology.

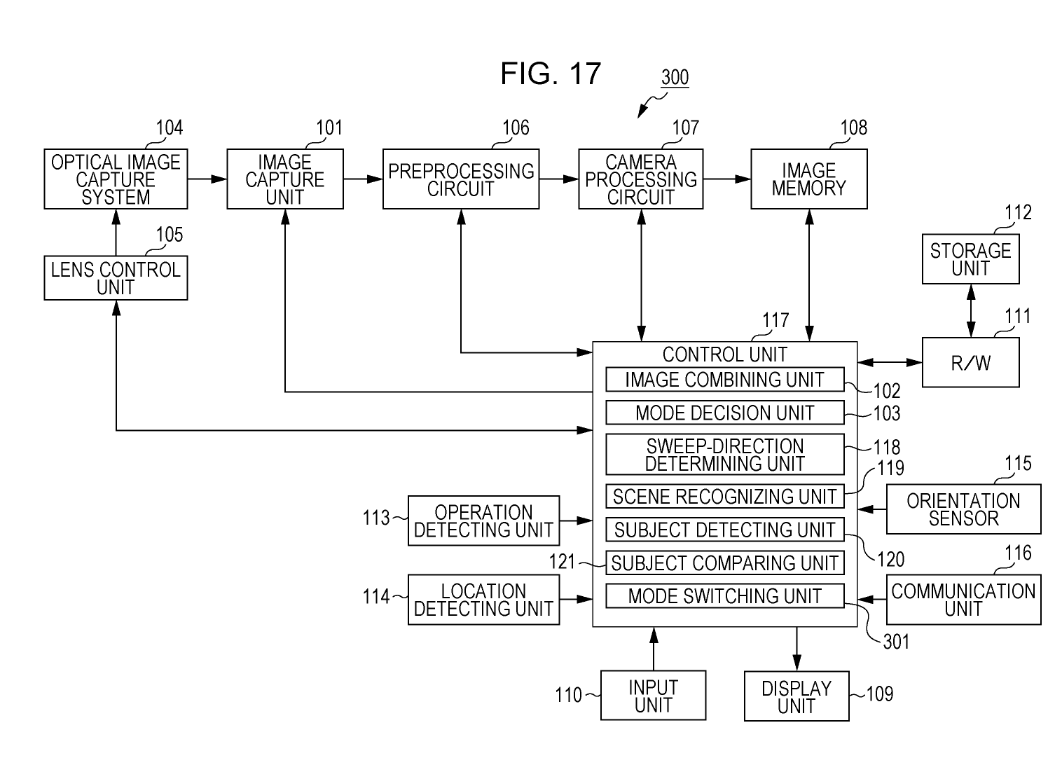

FIG. 17 is a block diagram illustrating the configuration of an image capture apparatus 300 according to a modification of the present technology. In this modification, the image capture apparatus 300 includes a mode switching unit 301, instead of the recommendation processing unit 122. The image capture apparatus 300, however, may have the mode switching unit 301 in addition to the recommendation processing unit 122, rather than instead of the recommendation processing unit 122. Since elements other than the mode switching unit 301 are the same as or similar to those in the first embodiment described above, descriptions thereof are not given hereinafter.

When the mode decision unit 103 decides that performing photography in the panoramic photography mode is appropriate, the mode switching unit 301 performs processing for automatically switching the mode, other than the panoramic photography mode, of the image capture apparatus 100 to the panoramic photography mode, in accordance with a result of the derision. As a result, even a user who does not know how to perform input to switch the mode to the panoramic photography mode can utilize the panoramic photography mode.

Unlike the embodiments described above, whether or not the panoramic photography mode is optimum may also be decided based on already photographed images stored in the storage unit 112 or the like. This point will now be described.

With respect to an arbitrary reference image in the already photographed images stored in the storage unit 112 or the like and one or more images that are continuous with the reference image in the photography order, a decision is made for the first determination criterion to third determination criterion described above in the first embodiment. When it is decided that any of the determination criteria is satisfied, a notification indicating that performing photography in the panoramic photography mode is optimum is issued to thereby recommend the panoramic photography mode to the user. The reference image is, for example, a most-recently photographed image.

The decision in the second embodiment may also be made with respect to one of the already photographed images stored in the storage unit 112 or the like. This also makes it possible to recommend the panoramic photography mode to the user.

The panoramic photography mode may also be recommended while the image used for the decision is being presented. Such an arrangement makes it possible to recognize at first sight which subject is suitable for photography in the panoramic photography mode. According to this modification, the panoramic photography mode can be recommended not only when the user holds the image capture apparatus 100 and is about to perform photography, but also after he or she finishes the photography.

The present technology can also employ the following configuration.

(1) An image capture apparatus including: an image capture unit configured to perform image capture to convert incident light into an electrical signal to generate one or more images; an image combining unit configured to combine a plurality of images generated by the image capture unit to generate an image having a size that is greater than or equal to an angle of view; and a mode decision unit configured to decide whether or not generating, performed by the image combining unit, the image having a size that is greater than or equal to the angle of view is optimum, on the basis of the one or more images generated by the image capture unit.

(2) The image capture apparatus according to (1), wherein the mode decision unit makes the decision on the basis of a degree of displacement between a plurality of images sequentially acquired by the image capture unit.

(3) The image capture apparatus according to (2), further including: an operation detecting unit configured to detect an operation performed by a user, wherein, when a displacement between the images in a direction that is substantially orthogonal to an operation direction indicated by information regarding the operation detected by the operation detecting unit is in a predetermined range, the mode decision unit decides that performing photography in a mode for photographing an image having a size that is greater than or equal to an angle of view is optimum.

(4) The image capture apparatus according to (1), wherein the mode decision unit makes the decision on the basis of a connection between subjects in images sequentially acquired by the image capture unit.

(5) The image capture apparatus according to (1), wherein the mode decision unit makes the decision by predicting the presence of an image adjacent to the one or more of the images acquired by the image capture unit.

(6) The image capture apparatus according no one of (1) to (5), further including: a display unit configured to display at least one of the images, wherein, when the mode decision unit decides that a mode for photographing an image having a size that is greater than or equal to an angle of view is optimum, the display unit performs display to notify the user that the mode is optimum.

(7) The image capture apparatus according to (6), wherein the display unit displays a character string to notify the user that the mode for photographing an image having a size that is greater than or equal to an angle of view is optimum.

(8) The image capture apparatus according to (6) or (7), wherein, when the user is notified that the mode for photographing an image having a size that is greater than or equal to an angle of view is optimum, the display unit displays a sample image photographed in the mode for photographing an image having a size that is greater than or equal to an angle of view.

(9) The image capture apparatus according to (8), further including: a scene recognizing unit configured to recognize a scene in the one or more images, wherein the sample image is an image corresponding to the scene recognized by the scene recognizing unit.

(10) The image capture apparatus according to one of (6) to (9), further including: an input unit configured to receive an input from the user, wherein, when the user is notified that the mode for photographing an image having a size that is greater than or equal to an angle of view is optimum, the user is allowed to select, by performing an input on the input unit, whether or not the image capture apparatus is to enter the mode for photographing an image having a size that is greater than or equal to an angle of view.

(11) The image capture apparatus according to one of (1) to (10), wherein the mode decision unit decides that photographing an image having a size that is greater than or equal to an angle of view is optimum, an operation mode of the image capture apparatus is switched to the mode for photographing an image having a size that is greater than or equal to an angle of view.

(12) The image capture apparatus according to one of (1) to (11), further including: a storage unit configured to store therein a photographed image, wherein, on the basis of a photographed image generated by the image capture unit and stored in the storage unit, the mode decision unit decides whether or not generating, performed by the image combining unit, an image having a size that is greater than or equal to the angle of view is optimum.

(13) The image capture apparatus according to one of (1) to (12), wherein the image having a size that is greater than or equal to the angle of view is an image acquired by photography by drawing a trace.

(14) An image capture method including: performing image capture to convert incident light into an electrical signal to generate one or more images; and deciding whether or not generating an image having a size that is greater than or equal to an angle of view is optimum, on the basis of the generated one or more images.

(15) An image capture program for causing a computer to execute an image capture method including: performing image capture to convert incident light into an electrical signal to generate one or more images; and deciding whether or not generating an image having a size that is greater than or equal to an angle of view is optimum, on the basis of the generated one or more images.

It should be understood by those skilled in the art that various modifications, combinations, sub-combinations and alterations may occur depending on design requirements and other factors insofar as they are within the scope of the appended claims or the equivalents thereof.

What is claimed is:

1. An image capture apparatus comprising:
an image capture unit configured to perform image capture to convert incident light into an electrical signal to generate one or more images;
an image combining unit configured to combine a plurality of images generated by the image capture unit to generate an image having a size that is greater than or equal to an angle of view; and
a mode decision unit configured to decide whether or not generating, performed by the image combining unit, the image haying a size that is greater than or equal to the angle of view is optimum, on the basis of the one or more images generated by the image capture unit.

2. The image capture apparatus according to claim 1, wherein the mode decision unit makes the decision on the basis of a degree of displacement between a plurality of images sequentially acquired by the image capture unit.

3. The image capture apparatus according to claim 2, further comprising:
an operation detecting unit configured to detect an operation performed by a user,
wherein, when a displacement between the images in a direction that is substantially orthogonal to an operation direction indicated by information regarding the operation detected by the operation detecting unit is in a predetermined range, the mode decision unit decides shat performing photography in a mode for photographing an image having a size that is greater than or equal to an angle of view is optimum.

4. The image capture apparatus according to claim 1, wherein the mode decision unit makes the decision on the basis of a connection between subjects in images sequentially acquired by the image capture unit.

5. The image capture apparatus according to claim 1, wherein the mode decision unit makes the decision by predicting the presence of an image adjacent to the one or more of the images acquired by the image capture unit.

6. The image capture apparatus according so claim 1, further comprising:
a display unit configured to display at least one of the images,
wherein, when the mode decision unit decides that a mode for photographing an image having a size that is greater than or equal to an angle of view is optimum, the display unit performs display to notify the user that the mode is optimum.

7. The image capture apparatus according to claim 6, wherein the display unit displays a character string to notify the user that the mode for photographing an image having a size that is greater than or equal to an angle of view is optimum.

8. The image capture apparatus according to claim 6, wherein, when the user is notified that the mode for photographing an image having a size that is greater than or equal to an angle of view is optimum, the display unit displays a sample image photographed in the mode for photographing an image having a size that is greater than or equal to an angle of view.

9. The image capture apparatus according to claim 8, further comprising:
a scene recognizing unit configured to recognize a scene in the one or more images,
wherein the sample image is an image corresponding to the scene recognized by the scene recognizing unit.

10. The image capture apparatus according to claim 6, further comprising:
an input unit configured to receive an input from the user,
wherein, when the user is notified that the mode for photographing an image having a size that is greater than or equal to an angle of view is optimum, the user is allowed to select, by performing an input on the input unit, whether or not the image capture apparatus is to enter the mode for photographing an image having a size that is greater than or equal to an angle of view.

11. The image capture apparatus according so claim 1, wherein the mode decision unit decides that photographing an image having a size that is greater than or equal to an angle of view is optimum, an operation mode of the image capture apparatus is switched to the mode for photographing an image having a size that is greater than or equal to an angle of view.

12. The image capture apparatus according to claim 1, further comprising:
a storage unit configured to store therein a photographed image,
wherein, on the basis of a photographed image generated by the image capture unit and stored in the storage unit, the mode decision unit decides whether or not generating, performed by the image combining unit, an image having a size that is greater than or equal to the angle of view is optimum.

13. The image capture apparatus according to claim 1, wherein the image having a size that is greater than or equal to the angle of view is an image acquired by photography by drawing a trace.

14. An image capture method comprising:
performing image capture to convert incident light into an electrical signal to generate one or more images; and
deciding whether or not generating an image having a size that is greater than or equal to an angle of view is optimum, on the basis of the generated one or more images.

15. An image capture program or causing a computer to execute an image capture method comprising:
performing image-capture to convert incident light into an electrical signal to generate one or more images; and
deciding whether or not generating an image having a size that is greater than or equal to an angle of view is optimum, on the basis of the generated one or more images.
